(19) United States
(12) Patent Application Publication
(10) Pub. No.: US 2012/0210757 A1
(43) Pub. Date: Aug. 23, 2012

(54) Magnetic Lock Assembly

(76) Inventor: Frank L. Gentile, Seymour, CT (US)

(21) Appl. No.: 13/400,428

(22) Filed: Feb. 20, 2012

Related U.S. Application Data
(60) Provisional application No. 61/444,856, filed on Feb. 21, 2011.

(51) Int. Cl. E05B 47/00

(52) U.S. Cl. 70/276

(57) ABSTRACT

A magnetic lock assembly comprises a lock body defining a chamber. A plunger is located within the chamber. A longitudinal member is located within the chamber and is moveable between block and unblock positions. A transverse member is located proximate to the longitudinal member and is moveable between engaged and disengaged positions. When the longitudinal member is in the block position, the longitudinal member inhibits movement of the transverse member from the engaged position to the disengaged position, such that the transverse member in the engaged position inhibits movement of the plunger from a locked position to an unlocked position. Orienting a key magnet near the longitudinal member urges the longitudinal member toward the unblock position, at which the transverse member is moveable from the engaged position to the disengaged position when the plunger is moved from the locked position to the unlocked position.

### CROSS REFERENCES TO RELATED APPLICATIONS

This application claims priority to U.S. provisional application No. 61/444,856 filed Feb. 21, 2011, which is hereby incorporated by reference as if fully set forth herein.

### STATEMENT REGARDING FEDERALLY SPONSORED RESEARCH

Not applicable.

### BACKGROUND

The present disclosure relates generally to a magnetic lock assembly. More particularly, the disclosure describes a magnetic lock assembly configured to operate in cooperation with a corresponding magnetic key assembly.

Many conventional locks include internal lock components that are mechanically engaged by a key inserted into an opening in the lock. This general lock configuration incorporates a number of precision elements that must work in concert to ensure proper operation of the lock. In addition, the opening in the lock hampers the operational life and ultimate security afforded by the lock. For instance, debris, such as dust, water, and other contaminants can enter the lock through the opening and foul the internal lock components. Furthermore, nefarious characters exploit the key opening in efforts to tamper with and defeat the security aspects of the lock.

In light of at least the above considerations, a need exists for a lock assembly having improved construction and operation.

### SUMMARY

In one aspect, a magnetic lock assembly comprises a lock body defining a chamber. A plunger is located within the chamber and is moveable between a locked position and an unlocked position. A longitudinal member is located within the chamber, the longitudinal member is moveable along a substantially longitudinal axis between a block position and an unblock position. A transverse member is located within the chamber and is proximate to the longitudinal member, the transverse member is moveable along a substantially transverse axis between an engaged position and a disengaged position. When the longitudinal member is in the block position, the longitudinal member inhibits movement of the transverse member from the engaged position to the disengaged position, such that the transverse member in the engaged position inhibits movement of the plunger from the locked position to the unlocked position. Orienting a key magnet near the longitudinal member urges the longitudinal member from the block position to the unblock position, at which the transverse member is moveable from the engaged position to the disengaged position when the plunger is moved from the locked position to the unlocked position.

In another aspect, a magnetic lock assembly comprises a lock body defining a chamber. A plunger is located within the chamber and is moveable between a locked position and an unlocked position. A detent is engaged with the plunger and is configured to extend from the lock body when the plunger is in the locked position and is configured to be retractable toward the plunger when the plunger is in the unlocked position. A longitudinal member is located within the chamber, the longitudinal member is moveable between a block position and an unblock position. A transverse member is located adjacent to the plunger, the transverse member is moveable between an engaged position and a disengaged position. When the longitudinal member is in the block position, the longitudinal member inhibits movement of the transverse member from the engaged position to the disengaged position, such that the transverse member in the engaged position inhibits movement of the plunger from the locked position to the unlocked position. Orienting a key magnet near the longitudinal member urges the longitudinal member from the block position to the unblock position. When the longitudinal member is in the unblock position, urging the detent toward the plunger moves the plunger from the locked position to the unlocked position, such that the plunger moves the transverse member from the engaged position to the disengaged position.

In a further aspect, a magnetic lock assembly comprises a lock body defining a chamber, a substantially longitudinal guideway, and a substantially transverse guideway. A plunger is located within the chamber and is moveable between a locked position and an unlocked position. A longitudinal member is slidably supported in the substantially longitudinal guideway along a substantially longitudinal axis between a block position and an unblock position. A transverse member is slidably supported in the substantially transverse guideway along a substantial transverse axis between an engaged position and a disengaged position. The substantially longitudinal guideway intersects the substantially transverse guideway. When the longitudinal member is in the block position, the transverse member is inhibited from moving from the engaged position to the disengaged position by the longitudinal member. Orienting a key magnet near the longitudinal member urges the longitudinal member from the block position to the unblock position, at which the transverse member is moveable from the engaged position to the disengaged position.

In yet another aspect, a magnetic key assembly comprises a body having a grip extending from the body. A lever is pivotally coupled to at least one of the body and the grip. A collet is coupled to the body and has multiple resilient fingers. A key magnet is slidably seated within the collet. Pivoting the lever moves the key magnet relative to the collet to deform the multiple resilient fingers.

The above and other aspects of the disclosure will be apparent from the description that follows. In the detailed description, preferred example embodiments will be described with reference to the accompanying drawings. These embodiments do not represent the full scope of the invention; rather, the invention may be employed in many other embodiments. Reference should therefore be made to the claims for determining the full breadth of the invention.

### BRIEF DESCRIPTION OF THE DRAWINGS

FIG. 1 is an isometric view of an example magnetic lock assembly and an example magnetic key assembly.

FIG. 2 is a section view of the example magnetic lock assembly along line 2-2 of FIG. 1 illustrating an example longitudinal member in a block position and an example transverse member in an engaged position.

FIG. 3 is an exploded, isometric view of a portion of the example magnetic lock assembly.

FIG. 4 is another exploded, isometric view of the portion of the example magnetic lock assembly shown in FIG. 3.

FIG. 5 is a section view along line 5-5 of FIG. 3.

FIG. 6 is a partial, section view of the example magnetic key assembly oriented proximate to the example magnetic lock assembly.

FIG. 7 is a partial, isometric section view of the example magnetic key assembly along line 7-7 of FIG. 1.

FIG. 8 is a section view of the example magnetic lock assembly shown in FIG. 2 illustrating the example longitudinal member in an unblock position.

FIG. 9 is a section view of the example magnetic lock assembly shown in FIG. 2.

FIG. 10 is a section view of the example magnetic lock assembly shown in FIG. 2 illustrating the example transverse member in a disengaged position.

FIG. 11 is a partial section view of another example magnetic lock assembly.

### DETAILED DESCRIPTION OF THE PREFERRED EXAMPLE EMBODIMENTS

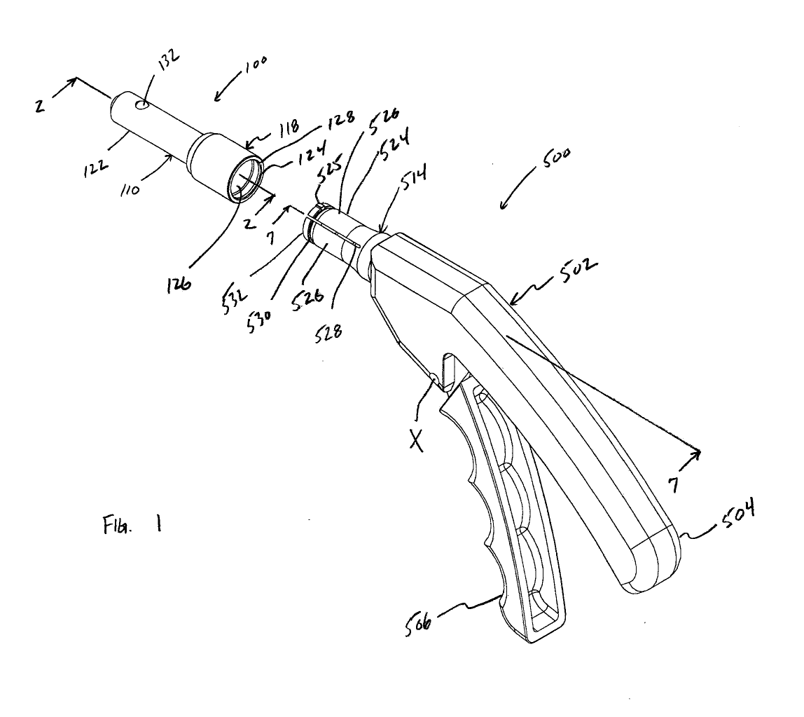

An example magnetic lock assembly is shown in FIG. 1 in the form of a magnetic barrel lock assembly (100) (“lock assembly (100)”). In addition, an example magnetic key assembly is illustrated in FIG. 1 in the form of a pistol-grip style magnetic key assembly (500) (“key assembly (500)”). One skilled in the art, given the benefit of this disclosure, will understand that the inventive concepts can be adapted for use with a variety of magnetic lock assembly and magnetic key assembly configurations, and are not unduly limited by the example lock assemblies and key assembly described herein.

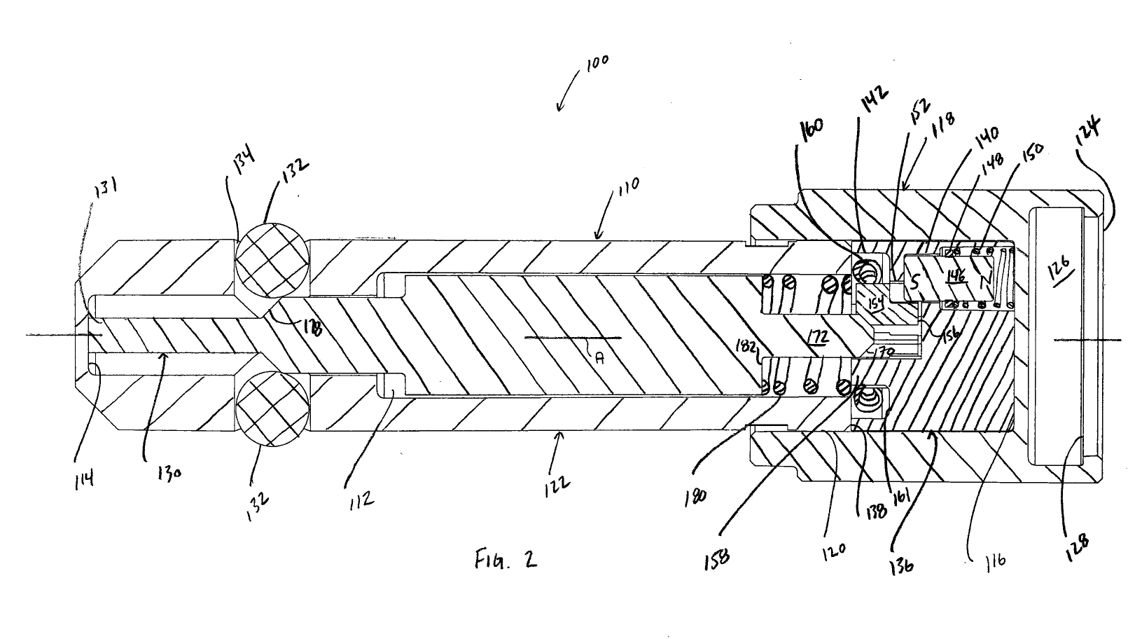

In the example configuration, and with additional reference to FIG. 2, the lock assembly (100) includes a lock body (110) having a generally cylindrical form factor. The lock body (110) defines a chamber (112) having a first end (114) and a second end (116) opposite to the first end (114). The lock body (110) is preferably metallic (e.g., hardened steel) to provide resistance to cutting and deformation; however, certain applications may allow the lock body (110) to be constructed from plastic or other non-metallic materials.

The example lock body (110) includes a cap (118) that engages (e.g., is welded to) an end (120) of a cylindrical housing (122). In other constructions the cap (118) may be integrally formed with the balance of the cylindrical housing (122). The cap (118) includes an opening (124) allowing access into a cavity (126) that is defined within the cap (118). The cap (118) further includes an annular lip (128) formed about a periphery of the cap (118) that is configured to selectively engage with the example key assembly (500) to allow installation and removal of the lock assembly (100). In some embodiments, the lock assembly (100) may include one or more seals (e.g., o-rings) located adjacent openings and couplings to inhibit environmental contaminants (e.g., moisture, dirt, insects, and the like) from degrading the operation and/or continued performance of the lock assembly (100). The cap (118) is also preferably metallic and similarly resistant to tampering. Furthermore, tampering with the internal operation of the example lock assembly (100) is inhibited as no key opening is present in the cap (118), which would allow access to the internal lock components.

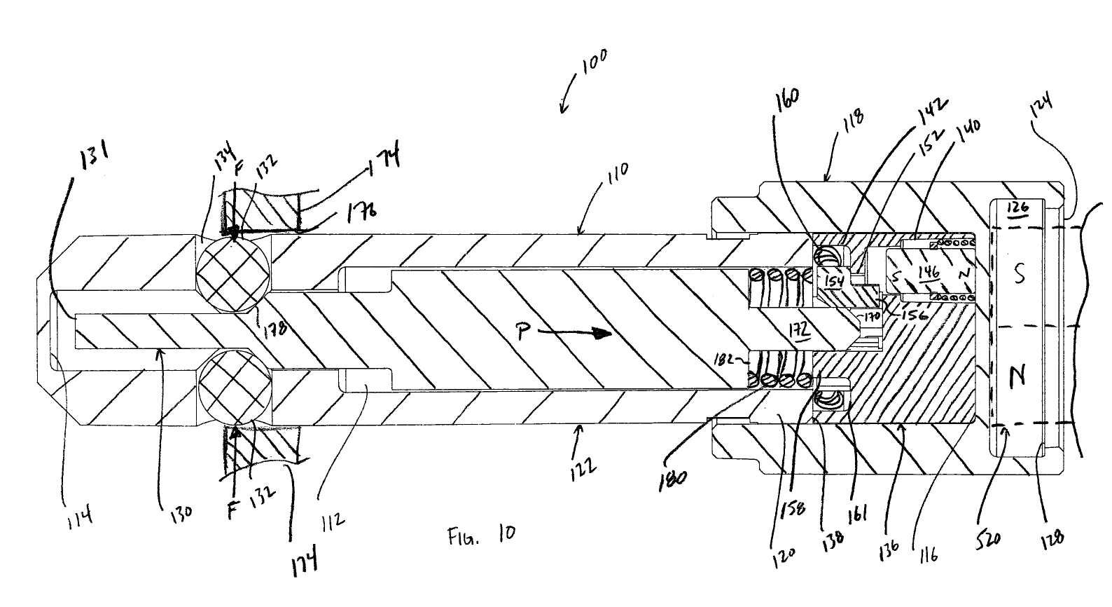

A plunger (130) is located within the chamber (112) such that the example plunger (130) can be moved axially along a longitudinal axis (A) (only annotated in FIG. 2) between a locked position (shown in FIG. 2) and an unlocked position (shown in FIG. 10). In the locked position, an end (131) of the plunger (130) abuts the first end (114) of the chamber (112), shown for example in FIG. 2. The plunger (130) is generally cylindrical to provide a compatible form factor with the cylindrically shaped chamber (112) formed by the lock body (110). The lock body (110), the chamber (112), and the plunger (130) may be configured with alternative similar or distinct form factors (e.g., oval, rhomboidal, etc. when viewed in transverse cross-section) provided the plunger (130) is capable of operation within the chamber (112), that is, the plunger (130) can move between the locked and unlocked positions during operation of the lock assembly (100). Furthermore, the plunger (130) is preferably metallic to provide sufficient robustness; again, however, when application requirements allow, the plunger (130) may be constructed, in part, from plastic or any other suitable non-metallic material(s) (e.g., composites), provided the plunger (130) is sufficiently robust to accommodate the application requirements.

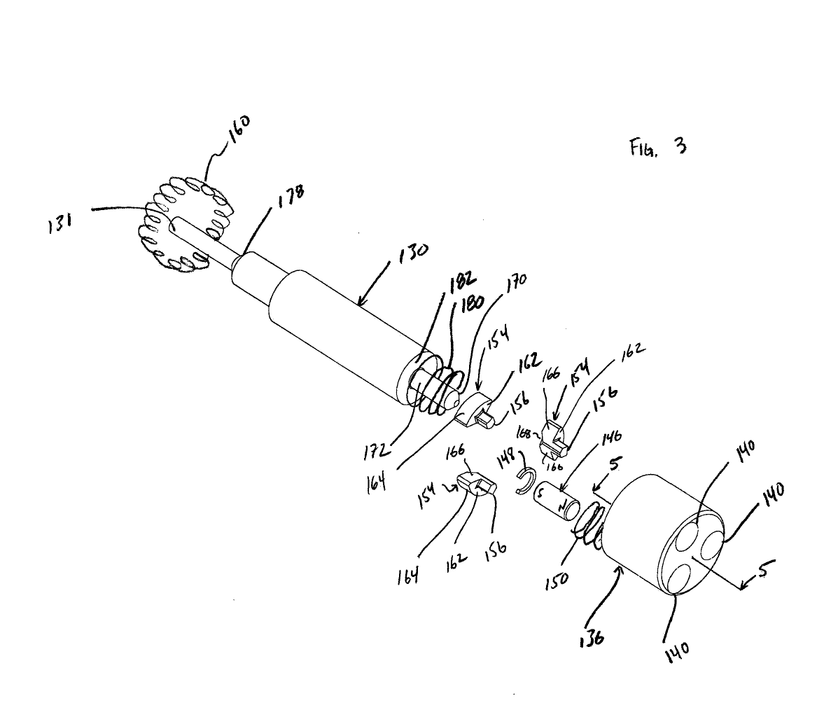

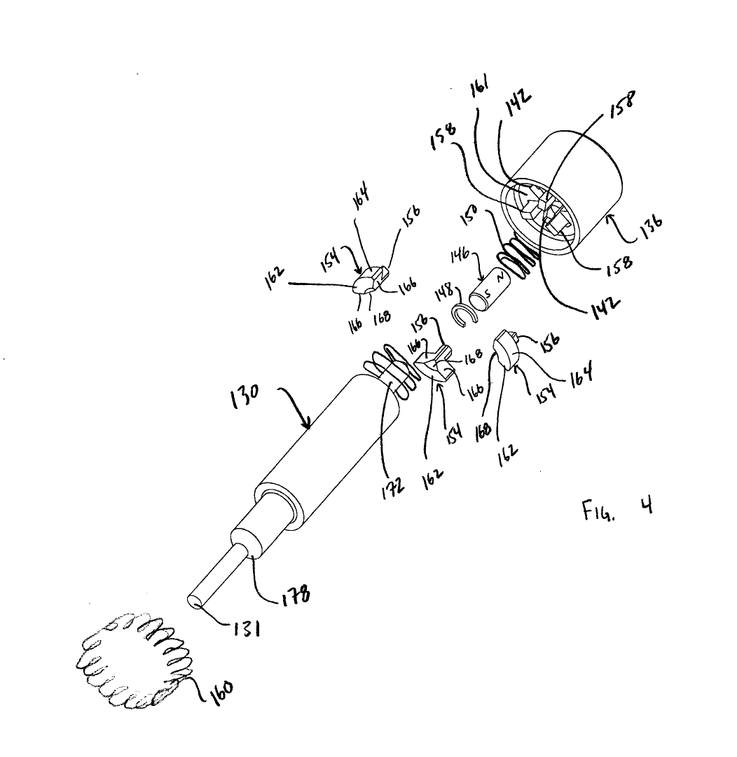

With additional reference to FIGS. 3 and 4, the example embodiment of the plunger (130) is configured to engage a pair of detents in the form of balls (132). The balls (132) are captured in a lateral passage (134) that is formed through the lock body (110) and that intersects with the chamber (112). The detent(s) may include pins, blocks, and the like, and be incorporated as understood by one of ordinary skill in the art. When the lock assembly (100) is locked, that is, the plunger (130) is restrained in the locked position (shown in FIG. 2), the plunger (130) inhibits the balls (132) from retracting inward into the lock body (110), because a radially inward force on the balls (132) is counteracted by the fixed plunger (130). Conversely, when the lock assembly (100) is unlocked, that is, when the plunger (130) is allowed to move toward the unlocked position (shown in FIG. 10), the balls (132) may be configured to fully retract into the lock body (110) toward the plunger (130) from the extended position. Thus, a radially inward force applied to the balls (132) is transferred to the plunger (130) to move the plunger (130) axially along the axis (A) when the lock assembly (100) has been unlocked by a mating key assembly (500). When the plunger (130) returns to the locked position, the balls (132) are urged outward by engagement with the plunger (130) and extend from the lock body (110). As a result, the lock assembly (100) is inhibited from axial movement when engaged with a mating lock member, such as a panel lock for a utility access box (not shown), as is understood by one of ordinary skill in the art.

In the example embodiment, movement of the plunger (130) from the locked position to the unlocked position is restrained by components within the chamber (112). In one form, the plunger (130) is ultimately moved from the locked position to the unlocked position as a result of force applied to the detent (i.e., the example balls (132)), such as when the lock assembly (100) is being installed or uninstalled from an application. To provide the locking feature, the example embodiment incorporates longitudinal members that selectively inhibit movement of respective transverse members, which in turn inhibit movement of the plunger (130). The appropriate key assembly (500) activates the lock assembly (100) by moving all of the longitudinal members out of blocking engagement with the respective transverse members, thus allowing the transverse members to move out of blocking engagement with the plunger (130).

With specific reference to FIGS. 2-5, an example interaction and configuration of longitudinal members and transverse members is illustrated in detail. The longitudinal members and the transverse members are supported and guided during operation in a hub (136). The hub (136), which is generally in the form of a cylinder, is seated in the chamber (112) and positioned between the second end (116) and an end face (138) of the cylindrical housing (122). The hub (136) may be formed of sintered cobalt, or any other suitable process/material given the specific application requirements.

In the example embodiment, the hub (136) defines three longitudinal guideways (140) that are circumferentially equally spaced apart, and three transverse guideways (142) that are similarly equally spaced apart and aligned with the respective longitudinal guideways (140). Each of longitudinal guideways (140) is arranged to at least partially intersect a respective, mating transverse guideway (142). The intersection of a longitudinal guideway (140) with a transverse guideway (142) allows selective interference between longitudinal members and transverse members seated respectively therein.

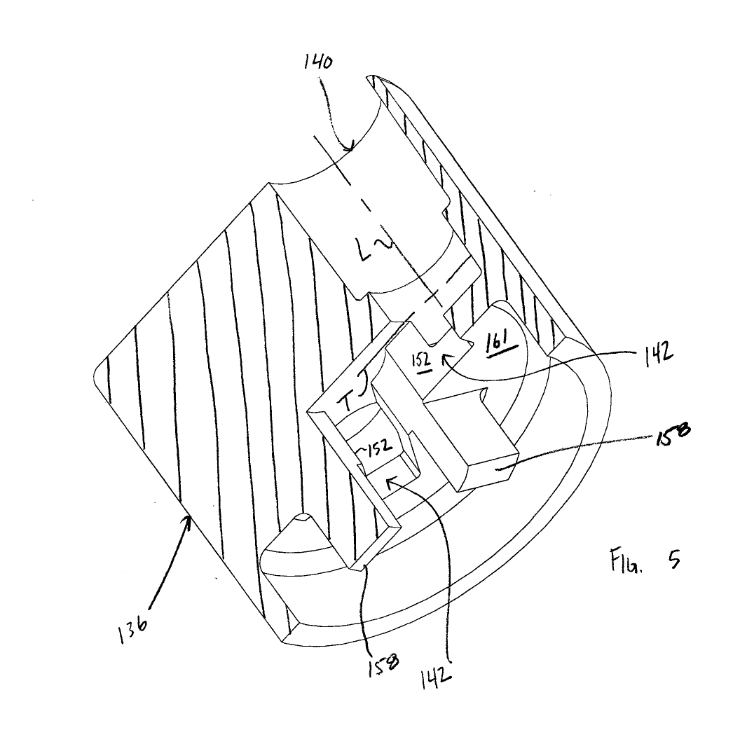

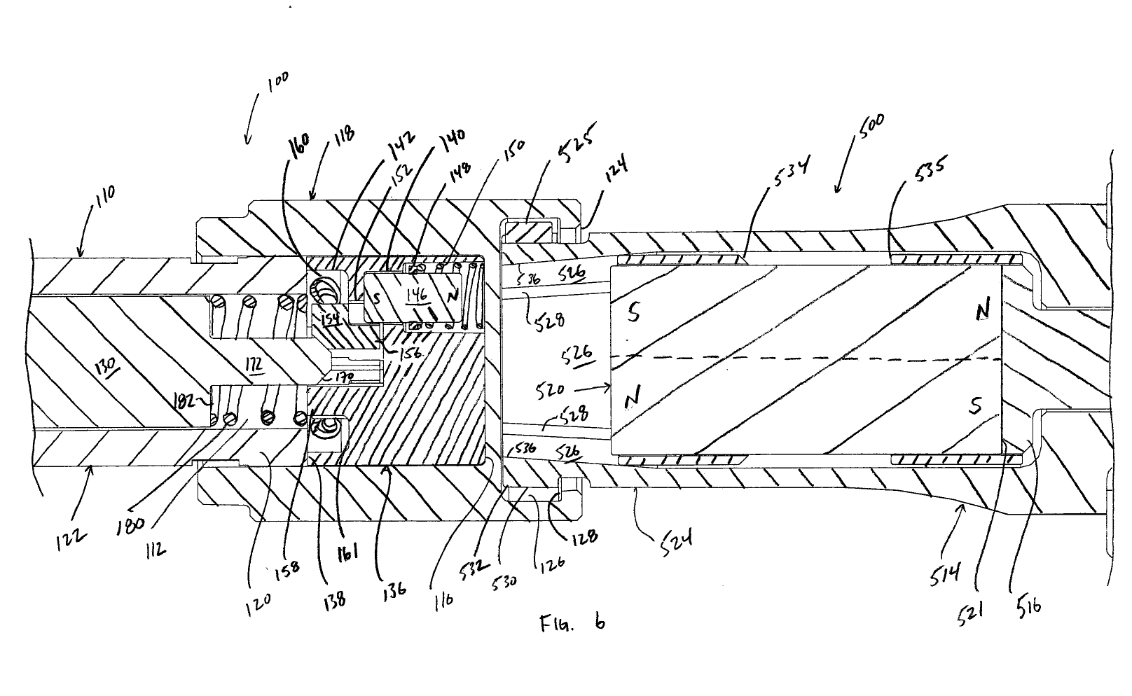

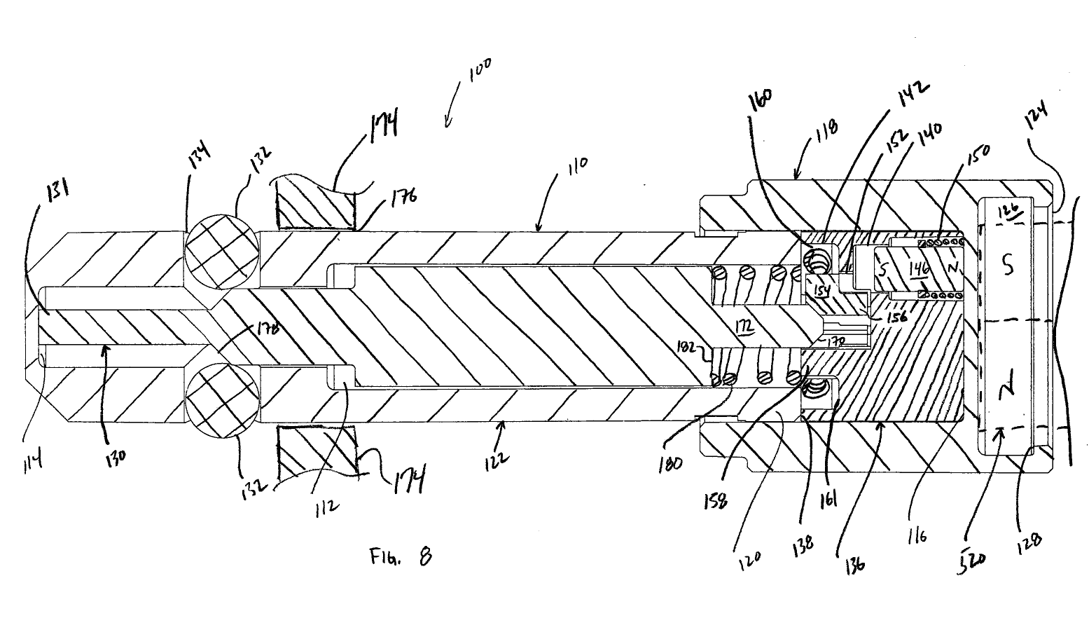

The longitudinal guideways (140) are generally cylindrical and, in the example embodiment, each has a stepped-wall arrangement defining an intermediate step (144) along the longitudinal guideway (140). Each longitudinal guideway (140) is configured to slidably receive a longitudinal member in the form of a cylindrically-shaped pin magnet (146) having a north pole (N) and an opposite south pole (S). The pin magnet (146) is moveable along a longitudinal axis (L) (only annotated in FIG. 5), which in the example embodiment is substantially parallel with the axis (A) of the lock body (110). The pin magnet is moveable between a block position (e.g., shown in FIG. 6) and an unblock position (e.g., shown in FIG. 8).

While only one of the pin magnets (146) (i.e., an example longitudinal member) is shown exploded from the hub (136) in FIGS. 3 and 4, each pin magnet (146) includes a retainer clip (148) that is, for example, press fit, adhered, integrally formed, etc. between the ends of the pin magnet (146). The C-shaped retainer clip (148) captures a longitudinal biasing member, shown in the form of a compression spring (150), against the second end (116) of the chamber (112), such that the compression spring (150) urges the pin magnet (146) toward the block position. The biasing force of the compression spring (150) is overcome when an appropriately configured key assembly (500) is engaged with the lock assembly (100) and actuated, as is described below in greater detail.

The transverse guideways (142) of the example embodiment are generally pie shaped and include a rectangular channel (152) extending in a radial direction relative to the axis (A). Each transverse guideway (142) is configured to slidably receive a transverse member illustrated in the form of a disc segment (154). Three circumferentially spaced dividers (158) extend from a face (161) of the hub (136) (best shown in FIG. 5) and provide separation between adjacent disc segments (154). Each disc segment (154), best shown in FIGS. 3 and 4, includes a guide post (156) that rides within the rectangular channel (152) as the disc segment (154) moves along a transverse axis (T) (only annotated in FIG. 5) between an engaged position (e.g., shown in FIG. 2) and a disengaged position (e.g., shown in FIG. 10). The transverse axis (T), shown in the example embodiment, is oriented substantially orthogonal to the axis (A) of the lock body (110).

Each disc segment (154) includes a pair of opposed walls (162) connected along one edge by an arcuate wall (164) and along a V-shaped portion by a pair of generally planar walls (166). In the example embodiment, the disc segments (154) may comprise sintered cobalt, however, the disc segments (154) may be of other constructions/compositions. The guide post (156) extends from one of the walls (162), and the opposite wall (162) includes a dimple (168). The dimple (168) is generally in the form of a partial cone segment configured to engage the plunger (130) (described below). A transverse biasing member, in the form of a ring-shaped helical spring (160), is positioned about the outer periphery of the three disc segments (154) to bias the disc segments (154) radially inward toward the axis (A) and into respective engaged positions. One skilled in the art, given the benefit of this disclosure, will appreciate that the transverse biasing member may take on a variety of different forms, such as an o-ring or an elastomeric band.

With continued reference to FIGS. 2-4, the dimples (168) in the disc segments (154) are configured to engage a beveled portion (170) formed near an end (172) of the plunger (130). The beveled portion (170) of the example embodiment is substantially conical such that axial movement of the plunger (130) can be utilized to engage the dimples (168) of each disc segment (154), and thus urge the disc segments (154) radially outward along the transverse guideways (142) once the pin magnets (146) have been moved out of blocking engagement.

In order to unlock the lock assembly (100), the pin magnets (146) (i.e., the example longitudinal members) are all moved from the block position (shown in FIG. 6) to the unblock position (shown in FIG. 8) by magnetic interaction with the example key assembly (500). The key assembly (500) is used to orient a matching key magnet near the pin magnets (146). A “matching” key magnet is one that defines the appropriate polarities required to actuate (e.g., attract) all of the pin magnets (146), thus allowing each of the disc segments (154) to slide radially outward in response to the axial movement of the plunger (130) toward the unlocked position.

The example key assembly (500), shown in FIGS. 1, 6, and 7, is generally in the form of a pistol-grip style that can be actuated to extend a permanent magnet to unlock the lock assembly (100). The key assembly (500) includes a body (502) having a grip (504) extending from the body (502) and a lever (506) that is pivotally coupled to the body (502) at pivot point (X) (e.g., by a hinge pin). The lever (506) includes a cam portion (508) that engages with a head (510) formed at a first end of a rod (512). The rod (512) is slidably captured by a collar (514) secured (e.g., threaded) within the body (502) and urged by a biasing member (515) (e.g., a compression spring) toward the cam portion (508).

A key magnet (520) (e.g., a permanent magnet) is engaged with a flange (516) formed at a second end of the rod (512). The flange (516) is secured to an end face (521) of the cylindrically shaped key magnet (520) via adhesive bonding; in other forms, the key magnet (520) may be integral with the rod (512). In the example embodiment, the key magnet (520) is a quad-pole magnet formed by separating a single bi-pole magnet along a longitudinal plane, rotating one half in the longitudinal plane one hundred and eighty degrees, and affixing the two halves together (e.g., via adhesive bonding). This modification results in the quad-pole key magnet (520) illustrated in FIG. 6 having opposed ends each defining a north pole (N) and a south pole (S). Given the benefit of this disclosure, one skilled in the art will appreciate the various alternative magnet configurations that can be incorporated with the other concepts described herein such that the key magnet (520) will actuate the desired combination of longitudinal member(s) when the key magnet (520) is positioned near the longitudinal member(s).

The key assembly (500) further includes a collet (524) that extends from the collar (514) and, in the example embodiment, generally surrounds the circumference of the key magnet (520). The collet (524) includes fingers (526) that are separated by longitudinal slits (528). Any number of fingers (526) may be formed by respective longitudinal slits (528) to obtain the application-specific resiliency of the fingers (526). A shoulder (530) is formed near a distal end (532) of the collet (524) and operates in combination with the fingers (526) to selectively axially capture the key assembly (500) and the lock assembly (100). The collet (524), and particularly the fingers (526), are preferably made of a resilient material (e.g., resilient plastic) such that the fingers (526) can be slightly deformed and yet have sufficient yield strength to return to the pre-deformed shape.

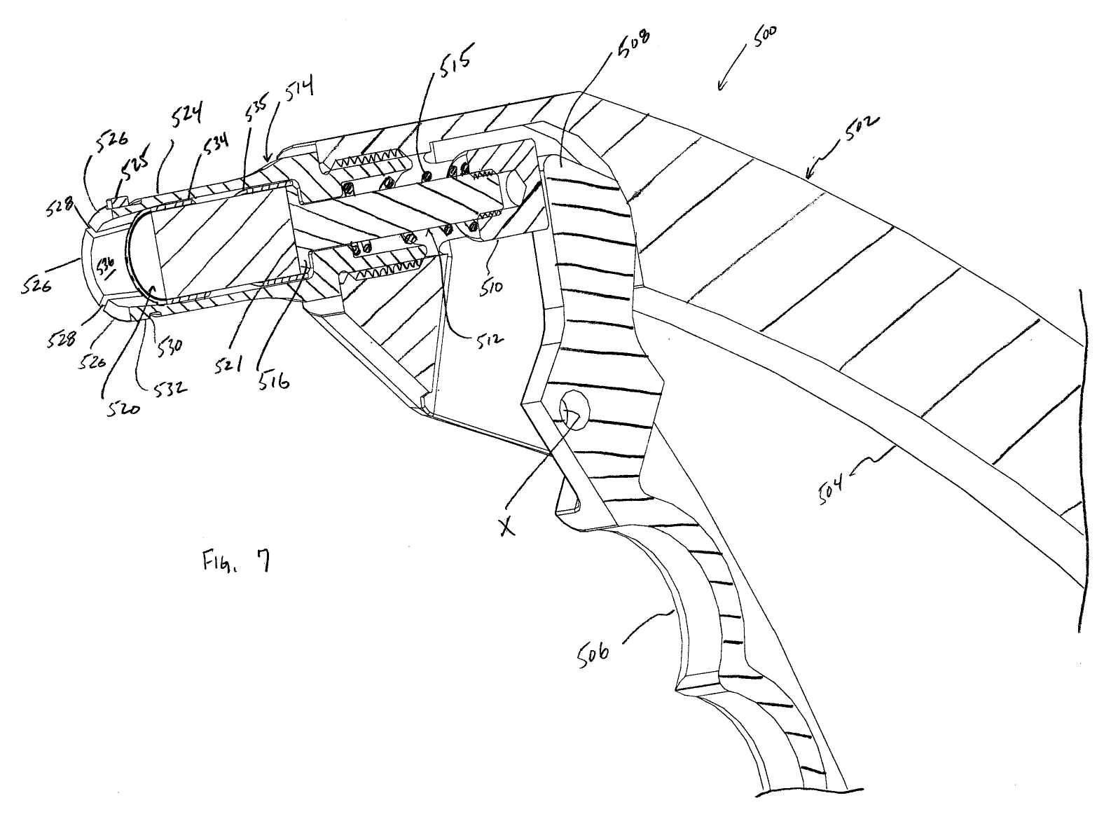

During operation, engaging the key assembly (500) with the lock assembly (100) and then actuating the key assembly (500) will unlock the lock assembly (100), such that the plunger (130) may be moved between the locked position and the unlocked position. As shown in FIG. 6, the distal end (532) of the collet (524) is inserted into the opening (124) in the cap (118) positioning the shoulder (530) of the collet (524) adjacent to the annular lip (128) of the cap (118). With additional reference to FIG. 7, actuating the lever (506) of the key assembly (500) causes the cam portion (508) to cam against the head (510) of the rod (512), thereby axially moving the rod (512) toward the distal end (532) of the collet (524) against the urging of the biasing member (515). As the key magnet (520) slides in conjunction with the rod (512), a pair of bushings (534, 535) (e.g., bronze bushings) secured about the key magnet (520) engage an inwardly tapered portion (536) of each finger (526). Fully extending the key magnet (520) flares the fingers (526) radially outward such that the shoulder (530) of the collet (524) captures the annular lip (128) of the cap (118). As a result, the lock assembly (100) and the key assembly (500) are axially coupled such that the key assembly (500) can transfer a force to the lock assembly (100), such as during installation or removal of the lock assembly (100).

Actuating the key assembly (500) positions the matching key magnet (520) near the pin magnets (146). The key magnet (520) then magnetically attracts each of the pin magnets (146) against the bias of the respective spring (150) to urge the pin magnets (146) from the block position (shown in FIGS. 2 and 6) to the unblock position (shown in FIGS. 8-10). The key magnet (520) of the key assembly (500) is shown simplified in FIGS. 8-10 with dashed lines.

The “matching” quad-pole key magnet (520) of the example embodiment is oriented to magnetically attract all three of the pin magnets (146) seated in the hub (136). Specifically, two of the three pin magnets (146) are oriented with a south pole adjacent to the second end (116) of the chamber (112), and the third pin magnet (146) is oriented with a north pole adjacent to the second end (116) of the chamber (112). As a result, when the key magnet (520) is oriented correctly, the two south-pole oriented pin magnets (146) are attracted to the north pole of the key magnet (520) while the single north-pole oriented pin magnet (146) is attracted to the south pole of the key magnet (520). An incorrect orientation between the key magnet (520) and the pin magnets (146) results in at least one of the pin magnets (146) being magnetically repelled from the key magnet (520) into the block position. The repelled pin magnet (146) inhibits radial movement of the respective disc segment (154) and hence axial movement of the plunger (130). One skilled in the art, given the benefit of this disclosure, will appreciate that other combinations and configurations of longitudinal member(s), transverse member(s), and key magnet(s) may be used depending upon the specific application requirements. The use of three pin magnets (146) and a quad-pole key magnet (520) are for illustrative purposes only.

As shown in FIG. 8-10, the south pole of the key magnet (520) is oriented near the north pole of the illustrated pin magnet (146), thus urging the pin magnet (146) into the unblock position. The collet (524) may include a protrusion (525) that helps orient the key assembly (500) into the predefined orientation to effectively attract each of the pin magnets (146) substantially simultaneously. Additionally, or alternatively, a mechanical interlock implemented via mating form factors between the key magnet (520) and the cavity (126) may be implemented to further limit the positioning of the key magnet (520), and thus the ability of a generic magnet to actuate each pin magnet (146) to unlock the lock assembly (100).

With each of the pin magnets (146) (i.e., example longitudinal members) moved from the block position into the unblock position, each of the respective disc segments (154) (i.e., example transverse members) remain biased toward the engaged position by the ring-shaped spring (160). However, the disc segments (154) may be moved from the engaged position to the disengaged position by the plunger (130) as the plunger (130) is moved from the locked position to the unlocked position.

In the example embodiment, and with continued reference to FIGS. 8-10, the lock assembly (100) is shown being uninstalled from an application (e.g., an enclosure panel lock assembly). The application includes a fixed structure (174) having an opening (176) through which the balls (132) and cylindrical housing (122) may pass through if the balls (132) are retracted (i.e., the lock assembly (100) is in the unlocked state). In one form, the force applied to install/uninstall the lock assembly (100) (e.g., the force provided by a user) results in a reaction between the rigid structure (174) and the balls (132).

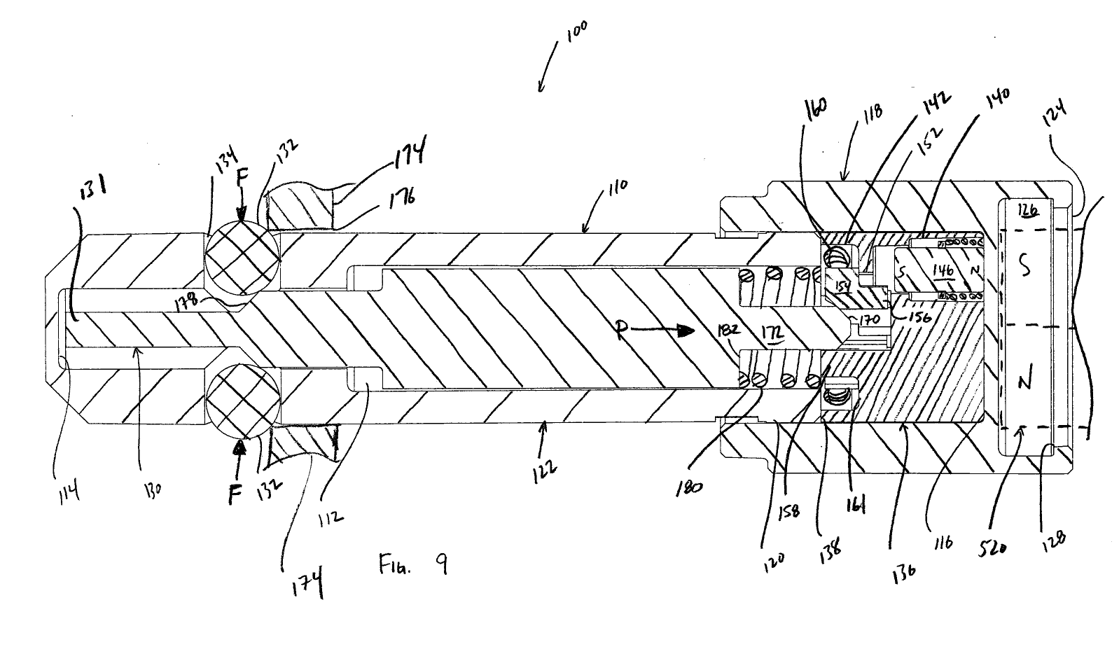

As shown in FIG. 9, the structure (174) engages the balls (132) and provides radially inward forces (F) that urge the balls (132) inward into engagement with the plunger (130). Specifically, the balls (132) engage another beveled portion (178) (best shown in FIG. 4). The axially skewed interface between the balls (132) and the beveled portion (178) results in at least a portion of the force (F) urging the plunger (130) axial from the locked position toward the unlocked position. The force (P) of the plunger (130) moves the plunger (130) against the urging of a plunger biasing member, illustrated in the form of a compression spring (180), which biases the plunger (130) toward the locked position. The compression spring (180) is located about an end (172) of the plunger (130) and is captured between a landing (182) of the plunger (130) and the hub (136). The force (P) of the plunger (130) drives the beveled portion (170) at the end (172) of the plunger (130) into engagement with the dimples (168) formed in each of the disc segments (154). When the pin magnets (146) are all in the unblock position, the force (P) of the plunger (130) moves the disc segments (154) radially outward along the transverse guideways (142) (against the biasing of the spring (160)) from the engaged position (shown in FIG. 8) toward the disengaged position (shown in FIG. 10). The dimples (168) ride along the beveled portion (170) (shown in FIG. 9) until the disc segments (154) are moved into the disengaged position (shown in FIG. 10) at which the respective guide posts (156) are radially adjacent to the plunger (130).

In the example embodiment, removing the force (F) urging the detents (i.e., the example balls (132)) into the retracted position, results in the spring (180) biasing the plunger (130) back toward the locked position, such that the beveled portion (178) urges the balls (132) back toward the extended position. The spring (160) further urges the disc segments (154) radially inward toward the axis (A) such that the disc segments (154) are moved back into the engaged position. Provided the key magnet (520) continues to orient the pin magnets (146) in the unblock position, the plunger (130) remains unlocked, but oriented in the locked position. Removing the key magnet (520) causes the springs (150) to urge the respective pin magnets (146) from the unblock position to the block position, whereat the pin magnets (146) again inhibit movement of the disc segments (154), and thus the plunger (130). In one form, the pin magnets (146) and the disc segments (154) may include mating skewed surfaces such that the return force of the spring (150) urging the pin magnet (146) toward the block position also urges the respective disc segment (154) toward the engaged position, without the use of the separate spring (160) acting directly upon the disc segments (154).

In the example embodiment, the pin magnet (146) (i.e., an example longitudinal member) and the key magnet (520) include at least a portion of a permanent magnet. In some forms, the permanent magnet may comprise a material having a high magnetic field to weight ratio, such as rare earth neodymium magnets.

In one embodiment, the magnet is a high strength grade rare earth magnetic material such as Neodymium Iron Boron (NdFeB), GR 45. However, the longitudinal member and the key magnet need not be made entirely of a permanent magnet. For example, a portion of the longitudinal member that engages and blocks the transverse member may be made of a robust material (e.g., steel) and have a permanent magnet coupled thereto to form the balance of the longitudinal member providing additional magnetic forces.

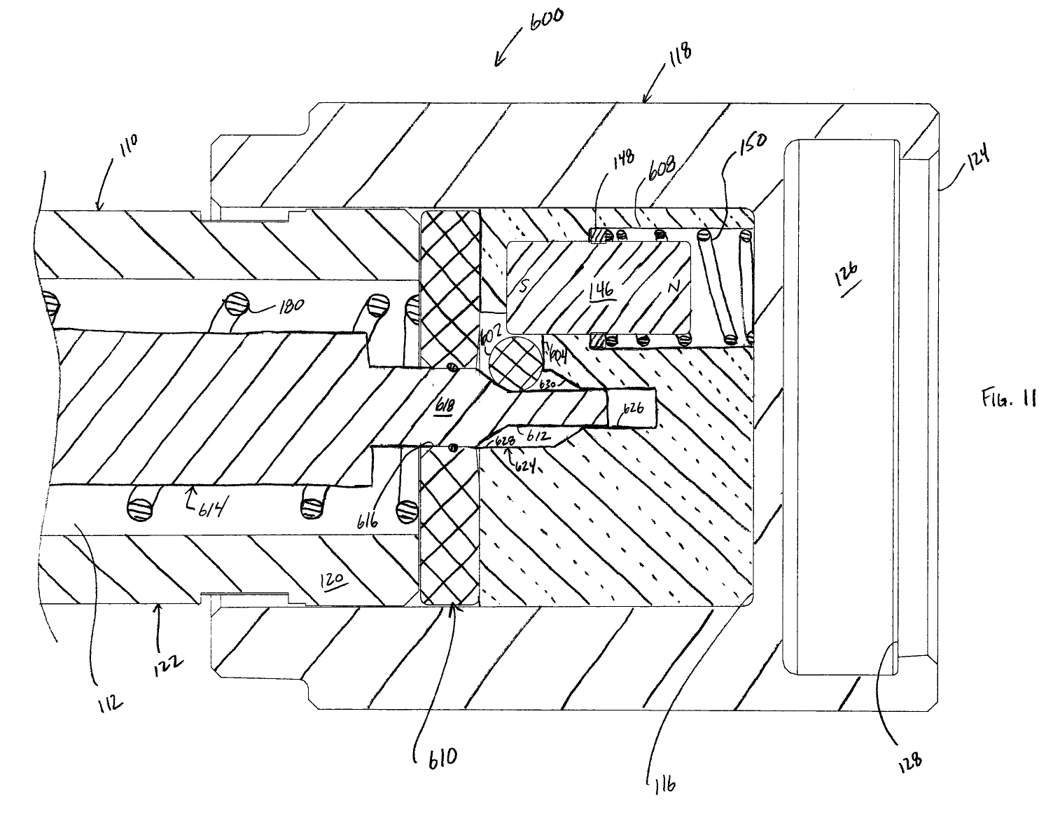

An alternative example lock assembly (600) is illustrated in FIG. 11. Similar elements to those described in connection with the lock assembly (100) are identified with identical reference numerals, and description of those similar elements is not duplicated. The alternative lock assembly (600) includes transverse members in the form of spheres (602) (e.g., ball bearings). Similar to the disc segments (154), each sphere (602) is moveable along a transverse guideway (604) between an engaged position (shown in FIG. 11) and a disengaged position, when the pin magnet (146) is moved from the block position (shown in FIG. 11) to the unblock position due to the attractive forces of a key magnet (not shown). A cylindrical hub (606) defines the transverse guideways (604) and the longitudinal guideways (608). However, the hub (606) is seated between the second end (116) of the chamber (112) and a circular disc (610) positioned directly adjacent to the end face (138) of the cylindrical housing (122).

The hub (606) and the circular disc (610) are configured to receive an end portion (612) of a plunger (614). Specifically, the disc (610) includes a circular opening (616) through which a cylindrical portion (618) of the plunger (614) rides along as the plunger (614) is moved between the locked position (shown in FIG. 11) and the unlocked position. An interior groove (620) is formed within the opening (616) and receives a seal in the form of an o-ring (622). The hub (606) defines a recess (624) that is configured to receive the end portion (612) of the plunger (614). The recess (624) includes a tip-end cylindrical portion (626), a base-end cylindrical portion (628), and an intermediate beveled portion (630), which cooperate to allow the end portion (612) of the plunger (614) to slide within the recess (624) between the locked position and the unlocked position.

During operation, a force applied to the detents (not shown) can urge the plunger (614) toward the unlocked position. As the plunger (614) attempts to move toward the unlocked position, the intermediate beveled portion (630) of the plunger (614) will engage the sphere (602) and urge the sphere (602) radially outward along the transverse guideway (604). As with the first embodiment of the lock assembly (100), the pin magnets (146) will inhibit movement of the spheres (602) when the pin magnets (146) are in the block position (shown in FIG. 11). If the example pin magnets (146) have been moved to the unblock position, the urging of the plunger (614) on the spheres (602) will result in the spheres (602) moving from the engaged position to the disengaged position, thereby allowing the plunger (614) to move from the locked position to the unlocked position. The pin magnet (146) is configured to engage the sphere (602) such that the pin magnet (146) (and the biasing force provided by the spring (150)) will urge the sphere (602) toward the engaged position when the attractive force of the key magnet is no longer acting upon the pin magnet (146).

As one skilled in the art will appreciate, how “near” the key magnet (520) and the example pin magnet (146) must be in order to move the pin magnet (146) is dependent upon a variety of variables, including, the magnetic field strength of the key magnet (520) and pin magnet (146), the material composition and form factor of the cap (118), the biasing force provided by the longitudinal biasing member, and any intermediate gap (e.g., an air gap), for instance. The distance required to operate the lock assembly may be tailored to meet given application requirements, as understood by one skilled in the art in consideration of this disclosure. Moreover, one skilled in the art, given the benefit of this disclosure, will appreciate the variety of compositions and constructions suitable for use in accordance with the magnetic lock assembly and magnetic key assembly as may be dictated by specific application requirements.

While there has been shown and described what is at present considered the preferred example embodiments of the concepts, it will be obvious to those skilled in the art that various changes and modifications can be made, given the benefit of this disclosure, without departing from the scope defined by the following claims.

We claim:

1. A magnetic lock assembly, comprising:
a lock body defining a chamber;
a plunger located within the chamber and moveable between a locked position and an unlocked position;
a longitudinal member located within the chamber, the longitudinal member moveable along a substantially longitudinal axis between a block position and an unblock position; and
a transverse member located within the chamber and proximate to the longitudinal member, the transverse member moveable along a substantially transverse axis between an engaged position and a disengaged position;
wherein when the longitudinal member is in the block position, the longitudinal member inhibits movement of the transverse member from the engaged position to the disengaged position, such that the transverse member in the engaged position inhibits movement of the plunger from the locked position to the unlocked position; and
wherein orienting a key magnet near the longitudinal member urges the longitudinal member from the block position to the unblock position, at which the transverse member is moveable from the engaged position to the disengaged position when the plunger is moved from the locked position to the unlocked position.

2. The magnetic lock assembly of claim 1, further comprising a detent configured to be extendable from the lock body when the plunger is in the locked position and configured to be retractable toward the lock body when the plunger is in the unlocked position.

3. The magnetic lock assembly of claim 1, wherein:
the lock body includes a cap adjacent to an end of the chamber defining a cavity; and
the key magnet is configured to be selectively captured in the cavity.

4. The magnetic lock assembly of claim 1, further comprising a hub located in the chamber, the hub defining a longitudinal guideway configured to slidably receive the longitudinal member and a transverse guideway configured to slidably receive the transverse member.

5. The magnetic lock assembly of claim 1, further comprising a longitudinal biasing member configured to urge the longitudinal member toward the block position.

6. The magnetic lock assembly of claim 1, further comprising a transverse biasing member configured to urge the transverse member toward the engaged position.

7. The magnetic lock assembly of claim 6, wherein the transverse biasing member comprises at least one of a coil spring, an elastomeric band, and an o-ring.

8. The magnetic lock assembly of claim 1, further comprising a plunger biasing member configured to urge the plunger toward the locked position.

9. The magnetic lock assembly of claim 1, wherein the longitudinal member is a substantially cylindrical magnet.

10. The magnetic barrel lock assembly of claim 9, wherein the substantially cylindrical magnet is made at least partially of Neodymium Iron Boron.

11. The magnetic lock assembly of claim 1, wherein the transverse member is at least one of a sphere and a disc segment.

12. The magnetic lock assembly of claim 1, wherein:
the longitudinal member comprises a plurality of circumferentially spaced longitudinal members; and
the transverse member comprises a plurality of circumferentially spaced transverse members;
wherein each of the plurality of circumferentially spaced longitudinal members is configured to operably interact with a respective one of the plurality of circumferentially spaced transverse members.

13. The magnetic lock assembly of claim 12, wherein:
the plurality of circumferentially spaced longitudinal members comprise magnets;
at least one set of adjacent magnets are configured with opposite magnetic pole orientation; and
the key magnet is a quad-pole magnet configured to attract each magnet when the key magnet is positioned near the magnets.

14. The magnetic lock assembly of claim 12, wherein:
the plurality of circumferentially spaced longitudinal members are equally spaced apart; and
the plurality of circumferentially spaced transverse members are equally spaced apart.

15. The magnetic lock assembly of claim 1, wherein:
the substantially longitudinal axis is substantially parallel with an axis of the lock body; and
the substantially transverse axis is substantially orthogonal to the axis of the lock body.

16. A magnetic lock assembly, comprising:
a lock body defining a chamber;
a plunger located within the chamber and moveable between a locked position and an unlocked position;
a detent engaged with the plunger and configured to extend from the lock body when the plunger is in the locked position and configured to be retractable toward the plunger when the plunger is in the unlocked position;
a longitudinal member located within the chamber, the longitudinal member moveable between a block position and an unblock position; and
a transverse member located adjacent to the plunger, the transverse member moveable between an engaged position and a disengaged position;
wherein when the longitudinal member is in the block position, the longitudinal member inhibits movement of the transverse member from the engaged position to the disengaged position, such that the transverse member in the engaged position inhibits movement of the plunger from the locked position to the unlocked position;
wherein orienting a key magnet near the longitudinal member urges the longitudinal member from the block position to the unblock position; and
wherein when the longitudinal member is in the unblock position, urging the detent toward the plunger moves the plunger from the locked position to the unlocked position, such that the plunger moves the transverse member from the engaged position to the disengaged position.

17. The magnetic lock assembly of claim 16, wherein the plunger defines a beveled portion configured to engage the detent, such that retracting the detent toward the plunger urges the plunger toward the unlocked position.

18. The magnetic lock assembly of claim 16, wherein the plunger defines a beveled portion configured to engage the transverse member, such that moving the plunger toward the unlocked position urges the transverse member toward the disengaged position.

19. A magnetic key assembly, comprising:
a body having a grip extending from the body;
a lever pivotally coupled to at least one of the body and the grip;
a collet coupled to the body and having multiple resilient fingers; and
a key magnet slidably seated within the collet;
wherein pivoting the lever moves the key magnet relative to the collet to deform the multiple resilient fingers.
